(19) United States
(12) Patent Application Publication
(10) Pub. No.: US 2018/0183110 A1
(43) Pub. Date: Jun. 28, 2018

(54) ELECTROCHEMICAL CELL WITH DIVALENT CATION ELECTROLYTE AND AT LEAST ONE INTERCALATION ELECTRODE

(71) Applicant: Eos Energy Storage, LLC, Edison, NJ (US)

(72) Inventors: George W. Adamson, Edison, NJ (US); Steven Amendola, Middletown, NJ (US); Michael Binder, Brooklyn, NY (US); Phillip J. Black, McConnellsburg, PA (US); Stefanie Sharp-Goldman, East Brunswick, NJ (US); Lois Johnson, Edison, NJ (US)

(21) Appl. No.: 15/896,673

(22) Filed: Feb. 14, 2018

Related U.S. Application Data
(63) Continuation of application No. 14/374,572, filed on Jul. 25, 2014, now abandoned.
(60) Provisional application No. 61/591,526, filed on Jan. 27, 2012.

(51) Int. Cl. H01M 10/36; H01M 10/24; H01M 4/24; H01M 10/26; H01M 4/50

(52) U.S. Cl. CPC H01M 10/36; H01M 2220/30; H01M 4/50; H01M 4/244; H01M 10/26; H01M 10/24

(57) ABSTRACT

The present invention provides a novel electrochemical cell that comprises a cathode, an anode, and an electrolyte, where an ion species present in the electrolyte intercalates into the cathode upon discharge of the electrochemical cell.

### CROSS REFERENCE TO RELATED APPLICATION

This PCT patent application claims the benefit of U.S. provisional application Ser. No. 61/591,526, filed on Jan. 27, 2012. The entire contents of this application are incorporated herein by reference.

### FIELD OF THE INVENTION

This invention is concerned with secondary electrochemical cells and batteries. In particular, this invention concerns electrolytes and electrodes for secondary electrochemical cells and methods of making the same.

### BACKGROUND

An electrical storage battery comprises one electrochemical cell or a plurality of electrochemical cells of the same type, the latter typically being connected in series to provide a higher voltage or in parallel to provide a higher charge capacity than provided by a single cell. An electrochemical cell comprises an electrolyte interposed between and in contact with an anode and a cathode. During battery discharge, the anode active material is oxidized and the cathode active material is reduced so that electrons flow from the anode through an external load to the cathode and ions flow through the electrolyte between the electrodes.

Electrical storage batteries are classified as either “primary” or “secondary” batteries. Primary batteries involve at least one irreversible electrode reaction and cannot be recharged with useful charge efficiency by applying a reverse voltage. Secondary batteries involve relatively reversible electrode reactions and can be recharged with acceptable loss of charge capacity over numerous charge-discharge cycles.

Traditional secondary batteries, such as lithium ion batteries, are presently used to power electronic devices such as electric vehicles, portable computers, and other hand held electronic devices (e.g., cellular telephones, music players, or global positioning navigation systems). However, traditional secondary batteries are generally constructed from high cost materials, heavy metals, caustic electrolytes, and other materials that are harmful to the environment. Furthermore, traditional secondary batteries suffer from performance degradation over numerous charge and discharge cycles. For example, traditional secondary batteries lose charge capacity over several charge cycles, they are Coulombically inefficient, or they possess an elevated impedance or internal resistance that negatively effects battery discharge.

### SUMMARY OF THE INVENTION

The electrochemical cells of the present invention provide environmentally safe energy storage systems that use low cost materials, reactants, and cell designs that are readily adaptable to accommodate a wide range of energy storage and power delivery applications. Moreover, the electrochemical cells of the present invention deliver superior battery performance including high energy density, high discharge/charge efficiency, and fast battery recharging.

In one aspect, the present invention provides a novel electrochemical cell that comprises a cathode, an anode, and an electrolyte, where an ion species present in the electrolyte intercalates into the cathode upon discharge of the electrochemical cell.

Another aspect of the present invention provides an electrochemical cell comprising an aqueous electrolyte comprising a divalent cation; a cathode comprising a layered material; and an anode comprising a metal, wherein the divalent cation intercalates into the layered material when the cell discharges; and the divalent cation de-intercalates from the cathode material and deposits onto the anode as a neutral metal when the cell charges.

In some embodiments, the divalent cation is selected from Zn²⁺, Ca²⁺, Mg²⁺, Fe²⁺, or any combination thereof. For example, the divalent cation is Zn²⁺. In some examples, the Zn²⁺ divalent cation is generated upon the dissolution of ZnSO₄, Zn(CHO₂)₂, Zn(NO₃)₂, Zn(CO₂CH₃)₂, ZnCl₂, ZnBr₂, Zn(ClO₄)₂, or any combination thereof in water. In such instances, the aqueous electrolyte further comprises a counter ion selected from SO₄²⁻, CHO⁻, NO₃⁻, CO₂CH₃⁻, Cl⁻, Br⁻, ClO₄³¹ , or any combination thereof.

In some embodiments, the aqueous electrolyte has a pH that is approximately neutral. For example, the electrolyte has a pH of from about 6 to about 8.

In some embodiments, the aqueous electrolyte has a pH that is slightly acidic. For example, the electrolyte has a pH of from about 3 to about 6.

In some embodiments, the layered material comprises a metal oxide, a mixed metal oxide, a metal sulfide, a zinc metal phosphate, a zinc metal oxide, or any combination thereof. For example, the layered material comprises manganese oxide, vanadium oxide, manganese vanadium oxide, TiS₂, WO₂Cl₂, or any combination thereof. In other examples, the layered material comprises a manganese oxide that undergoes a reduction in its oxidation state of 1 or more during the discharge of the electrochemical cell.

In some embodiments, the cathode comprises manganese oxide having a chemical formula of MnₓO_{y} where x is greater than or equal to 1, and y is greater than or equal to 2.

In some embodiments, the layered material comprises manganese vanadium oxide having a chemical formula of MnₓV_{z}O_{y}, where x is greater than or equal to 1, y is greater than or equal to 2, and z is greater than or equal to 1.

In some embodiments, the layered material comprises manganese oxide having a chemical formula of MnO₂, Mn₅O₈, Mn₃O₇.3H₂O, Mn₇O₁₄.3H₂O, Mn₄O₉.3H₂O, Mn₂O₄, Mn₄O₁₈.H₂O, or any combination thereof. For example, the layered material comprises Mn₅O₈ that comprises a power having a mean particle diameter of about 50 μm or less.

In some embodiments, the cathode is doped with Al, B, or any combination thereof.

In some embodiments, the cathode further comprises a carbon powder. For example, the cathode further comprises about 15 wt % or less of the carbon powder by weight of the cathode material. In other examples, the carbon powder comprises acetylene black, furnace black, channel black, graphite, activated carbon, graphene, or any combination thereof.

In some embodiments, the cathode further comprises an additive that stabilizes the crystal lattice structure of manganese oxide. For example, the additive comprises TiS₂, TiB₂, Bi₂O₃, or any combination thereof. In other examples, the additive is present at a concentration of about 20 wt % or less by weight of the cathode.

In some embodiments, the anode comprises a metal, and a portion of the metal transforms into a divalent cation when the cell is discharged. For example, the metal material comprises zinc (Zn) or magnesium (Mg).

In some embodiments, the cathode material, the anode material, or both further comprises a binder. In some examples, the binder comprises polyacrylonitrile, polyvinyl alcohol, polyvinyl chloride, polyethylene oxide, polytetrafluoroethylene, polyvinylidene difluoride, polymethylmethacrylate, or any combination thereof. In other examples, the binder is present at a concentration of from about 3 wt % to about 15 wt % by weight of the cathode material.

In some embodiments, the anode, the cathode, or both further comprises a current collector. In some examples, the current collector comprises one or more electrically conductive metals or an electrically conductive polymer material. For example, the current collector comprises a woven material, a non-woven material, or a combination thereof. In other examples, the current collector comprises a sheet of non-woven material that optionally comprises perforations.

Another aspect of the present invention provides an electrochemical cell comprising an aqueous electrolyte comprising a divalent cation comprising Zn²⁺, Mg²⁺, or a combination thereof; a cathode comprising metal oxide (e.g., manganese oxide or manganese vanadium oxide); and an anode comprising zinc metal, magnesium metal, or a combination thereof, wherein the aqueous electrolyte has a nearly neutral pH, the divalent cation intercalates into the cathode when the cell discharges; and the divalent cation deposits onto the anode material as a neutral metal when the cell charges.

In some embodiments, the divalent cation is Zn²⁺.

In some embodiments, the Zn²⁺ is generated upon the dissolution of ZnSO₄, Zn(CHO₂)₂, Zn(NO₃)₂, Zn(CO₂CH₃)₂, ZnCl₂, ZnBr₂, Zn(ClO₄)₂, or any combination thereof in water. In such instances, the aqueous electrolyte further comprises a counter ion selected from SO₄²⁻, CHO³¹ , NO₃⁻, CO₂CH₃⁻, Cl⁻, Br⁻, ClO₄⁻, or any combination thereof.

In some embodiments, the cathode comprises manganese oxide, and the manganese oxide is not substantially soluble in the electrolyte. For example, the manganese oxide has a chemical formula of MnOₓO_{y} where x is greater than or equal to 1, and y is greater than or equal to 2. In some embodiments, the cathode comprises manganese vanadium oxide having a chemical formula of MnₓV_{z}O_{y}, where x is greater than or equal to 1, y is greater than or equal to 2, and z is greater than or equal to 1. In other examples, the cathode material comprises manganese oxide having a chemical formula of MnO₂, Mn₅O₈, Mn₃O₇.3H₂O, Mn₇O₁₄.3H₂O, Mn₄O₉3H₂O, Mn₂O₄, Mn₄O₁₈.H₂O, or any combination thereof. And, in some embodiments, the cathode comprises manganese oxide having a predominant crystal structure of α-MnO₂, β-MnO₂, γ-MnO₂, δ-MnO₂, layered, or any combination thereof.

In some embodiments, the manganese oxide has a chemical formula of Mn₅O₈, and the manganese oxide comprises a power having a mean particle diameter of about 50 μm or less.

In some embodiments, the cathode further comprises a carbon powder. For example, the cathode further comprises about 15 wt % or less of the carbon powder by weight of the cathode. In some instances, the carbon powder comprises acetylene black, furnace black, channel black, graphite, activated carbon, graphene, or any combination thereof.

In some embodiments, the cathode further comprises an additive that stabilizes the crystal lattice structure of manganese oxide. For example, the additive comprises TiS₂, TiB₂, Bi₂O₃, or any combination thereof. In other examples, the additive is present at a concentration of about 20 wt % or less by weight of the cathode.

In some embodiments, the cathode is doped with Al, B, or any combination thereof.

In some embodiments, the anode comprises zinc metal.

In some embodiments, the anode comprises zinc metal and the divalent cation is Zn²⁺.

In some embodiments, the anode material, the cathode material, or both further comprises a binder, such as any of the binders described above.

In some embodiments, the anode, the cathode, or both further comprises a current collector, such as any of the current collectors described above.

Another aspect of the present invention provides a method of manufacturing an electrochemical cell comprising providing a cathode comprising a layered material; providing an anode comprising a metal; and providing an aqueous electrolyte comprising a divalent cation, wherein the divalent cation intercalates into the layered material when the cell discharges; and the divalent cation de-intercalates from the cathode material and deposits onto the anode material as a neutral metal when the cell charges.

In some implementations, the divalent cation is selected from Zn²⁺, Ca²⁺, Mg²⁺, Fe²⁺, or any combination thereof.

In some implementations, the divalent cation is Zn²⁺.

Some implementations further comprise dissolving ZnSO₄, Zn(CHO₂)₂, Zn(NO₃)₂, Zn(CO₂CH₃)₂, ZnCl₂, ZnBr₂, Zn(ClO₄)₂, or any combination thereof in water to generate the Zn²⁺ divalent cation.

In some implementations, the cathode material comprises a layered material comprising a metal oxide, a mixed metal oxide, a metal sulfide, a zinc metal phosphate, a zinc metal oxide, or any combination thereof.

In some implementations, the cathode material comprises manganese oxide, vanadium oxide, manganese vanadium oxide, TiS₂, WO₂Cl₂, or any combination thereof.

In some implementations, the cathode material comprises a metal oxide that undergoes a reduction in its oxidation state of 1 or more during the discharge of the electrochemical cell.

In some implementations, the cathode comprises manganese oxide having a chemical formula of MnOₓO_{y} where x is greater than or equal to 1, and y is greater than or equal to 2.

In some implementations, the cathode comprises manganese vanadium oxide having a chemical formula of MnₓV_{z}O_{y}, where x is greater than or equal to 1, y is greater than or equal to 2, and z is greater than or equal to 1.

In some implementations, the cathode comprises manganese oxide having a chemical formula of MnO₂, Mn₅O₈, Mn₃O₇.3H₂O, Mn₇O₁₄.3H₂O, Mn₄O₉.3H₂O, Mn₂O₄, Mn₄O₁₈.H₂O, or any combination thereof. In other embodiment, the cathode comprises manganese oxide having a predominant crystal structure of α-MnO₂, β-MnO₂, γ-MnO₂, δ-MnO₂, layered, or any combination thereof.

In some implementations, the cathode comprises Mn₅O₈, and the Mn₅O₈ comprises a powder having a mean particle diameter of about 50 μm or less.

In some implementations, the cathode further comprises carbon powder.

In some implementations, the cathode further comprises about 15 wt % or less of the carbon powder by weight of the electrode material.

In some implementations, the carbon powder comprises acetylene black, furnace black, channel black, graphite, activated carbon, graphene, or any combination thereof.

In some implementations, the cathode further comprises an additive that stabilizes the crystal lattice structure of manganese oxide.

In some implementations, the additive comprises TiS₂, TiB₂, Bi₂O₃, or any combination thereof.

In some implementations, the additive is present at a concentration of about 20 wt % or less by weight of the electrode material.

In some implementations, the anode material comprises a metal that undergoes an increase in its oxidation state of 1 or more during the discharge of the electrochemical cell.

In some implementations, the anode comprises zinc metal or magnesium metal.

In some implementations, the divalent cation is Zn²⁺, and the anode comprises zinc metal.

In some implementations, the anode material, the cathode material, or both further comprises a binder.

In some implementations, the binder comprises polyacrylonitrile, polyvinyl alcohol, polyvinyl chloride, polyethylene oxide, polytetrafluoroethylene, polyvinylidene difluoride, polymethylmethacrylate, or any combination thereof.

In some implementations, the binder is present at a concentration of from about 3 wt % to about 15 wt % by weight of the electrode material.

Some implementations further comprise providing a cathode current collector, an anode current collector, or both.

In some implementations, the cathode current collector, the anode current collector, or both comprises one or more electrically conductive metals or an electrically conductive polymer material.

In some implementations, the cathode current collector, the anode current collector, or both comprises a woven material, a non-woven material, or a combination thereof.

In some implementations, the cathode current collector, the anode current collector, or both comprises a sheet of non-woven material that optionally comprises perforations.

In some implementations, the cathode is doped with Al, B, or any combination thereof.

Another aspect of the present invention provides an electrochemical cell comprising an aqueous electrolyte comprising a divalent cation; a cathode comprising a cathode material; and an anode comprising an anode material, wherein the divalent cation intercalates into the cathode material and de-intercalates from the anode material when the cell discharges; and the divalent cation de-intercalates from the cathode material and intercalates into the anode material when the cell charges.

In some embodiments, the electrolyte comprises a nearly neutral pH. For example, the electrolyte has a pH from about 6 to about 8 (e.g., from about 6.5 to about 7.5).

In some embodiments, the aqueous electrolyte has a pH that is slightly acidic. For example, the electrolyte has a pH of from about 3 to about 6.

In other embodiments, the aqueous divalent cation is selected from Zn²⁺, Ca²⁺, Mg²⁺, Fe²⁺, or any combination thereof. For instance, the aqueous divalent cation is Zn²⁺. In some electrolytes, the Zn²⁺ divalent cation is generated upon the dissolution of ZnSO₄, Zn(CHO₂)₂, Zn(NO₃)₂, Zn(CO₂CH₃)₂, ZnCl₂, ZnBr₂, Zn(ClO₄)₂, or any combination thereof in water.

In other embodiments, the anode material, the cathode material, or both comprises a metal oxide, a mixed metal oxide, a metal sulfide, a zinc metal phosphate, a zinc metal oxide, or any combination thereof. For example, the anode material, the cathode material, or both comprises manganese oxide, vanadium oxide, manganese vanadium oxide, TiS₂, WO₂Cl₂, or any combination thereof. In other examples, the cathode material comprises a metal oxide that undergoes a reduction in its oxidation state of 1 or more during the discharge of the electrochemical cell. And, in some examples, the anode material comprises a metal oxide that undergoes an increase in its oxidation state of 1 or more during the discharge of the electrochemical cell.

In some embodiments, the cathode material comprises a manganese oxide, wherein the manganese oxide is not substantially soluble in the electrolyte. For example, the cathode material comprises manganese oxide having a chemical formula of MnₓO_{y} where x is greater than or equal to 1, and y is greater than or equal to 2.

In some embodiments, the cathode material comprises manganese vanadium oxide having a chemical formula of MnₓV_{z}O_{y}, where x is greater than or equal to 1, y is greater than or equal to 2, and z is greater than or equal to 1.

In other examples, the cathode material comprises manganese oxide having a chemical formula of MnO₂, Mn₅O₈, Mn₃O₇.3H₂O, Mn₇O₁₄.3H₂O, Mn₄O₉.3H₂O, Mn₂O₄, Mn₄O₁₈.H₂O, or any combination thereof. And, in some embodiments, the cathode material comprises manganese oxide having a predominant crystal structure of α-MnO₂, β-MnO₂, γ-MnO₂, δ-MnO₂, layered, or any combination thereof.

In some embodiments, the anode material comprises manganese oxide, wherein the manganese oxide is not substantially soluble in the electrolyte. For example, the anode material comprises manganese oxide having a chemical formula of MnₓO_{y} where x is greater than or equal to 1, and y is greater than or equal to 2. In some embodiments, the anode material comprises manganese vanadium oxide having a chemical formula of MnₓV_{z}O_{y}, where x is greater than or equal to 1, y is greater than or equal to 2, and z is greater than or equal to 1. In other examples, the anode material comprises manganese oxide having a chemical formula of MnO₂, Mn₅O₈, Mn₃O₇.3H₂O, Mn₇O₁₄.3H₂O, Mn₄O₉.3H₂O, Mn₂O₄, Mn₄O₁₈.H₂O, or any combination thereof. And, in some embodiments, the anode comprises manganese oxide having a predominant crystal structure of α-MnO₂, β-MnO₂, γ-MnO₂, δ-MnO₂, layered, or any combination thereof.

In other embodiments, the cathode material comprises manganese oxide, the anode material comprises manganese oxide, and the oxidation state of the manganese in the cathode material is greater than the oxidation state of the manganese in the anode material when the cell has an SOC of at least about 90%. For example, the cathode material comprises manganese oxide having an oxidation state of about 4 when the cell has an SOC of at least about 90%. In other examples, the anode material comprises manganese oxide having an oxidation state of about 2 when the cell has an SOC of at least about 90%.

And, in some embodiments, the cathode material comprises manganese oxide, the anode material comprises manganese oxide, and the oxidation state of the manganese in the cathode material is approximately equal to the oxidation state of the manganese in the anode material when the cell has an SOC of less than about 10%. For example, the cathode material comprises manganese oxide and the anode material comprises manganese oxide, and the oxidation state of the manganese in the cathode material and the manganese in the anode material is about 3 when the cell has an SOC of less than about 10%.

In other embodiments, the anode material, the cathode material, or both further comprises a carbon powder. For example, the anode material, the cathode material, or both further comprises about 15 wt % or less of the carbon powder by weight of the electrode material. In some instances, the carbon powder comprises acetylene black, furnace black, channel black, graphite, activated carbon, graphene, or any combination thereof.

In alternative embodiments, the anode material, the cathode material, or both further comprises an additive that stabilizes the crystal lattice structure of manganese oxide. In some examples, the additive comprises TiS₂, TiB₂, Bi₂O₃, or any combination thereof. In other examples, the additive is present at a concentration of about 20 wt % or less by weight of the electrode material.

And, in some embodiments, the anode material, the cathode material, or both further comprises a binder. In some instances, the binder comprises polyacrylonitrile, polyvinyl alcohol, polyvinyl chloride, polyethylene oxide, polytetrafluoroethylene, polyvinylidene difluoride, polymethylmethacrylate, or any combination thereof. In other instances, the binder is present at a concentration of from about 3 wt % to about 15 wt % (e.g., from about 4 wt % to about 12 wt % or from about 5 wt % to about 10 wt %) by weight of the electrode material (i.e., the cathode material and/or the anode material).

In some embodiments, the anode material, the cathode material, or both is doped with Al, B, or any combination thereof.

In other embodiments, the anode, the cathode, or both further comprises a current collector. In some instances, the current collector comprises one or more electrically conductive metals or an electrically conductive polymer material. In other instances, the current collector comprises a woven material, a non-woven material, or a combination thereof. For example, the current collector comprises a sheet of non-woven material that optionally comprises perforations.

Another aspect of the present invention provides an electrochemical cell comprising an aqueous electrolyte comprising Zn²⁺; a cathode comprising manganese oxide; and an anode comprising manganese oxide, wherein the Zn²⁺ intercalates into the cathode and de-intercalates from the anode when the cell discharges; and the Zn²⁺ de-intercalates from the cathode and intercalates into the anode when the cell charges.

In some embodiments, the Zn²⁺ is generated upon the dissolution of ZnSO₄, Zn(CHO₂)₂, Zn(NO₃)₂, Zn(CO₂CH₃)₂, ZnCl₂, ZnBr₂, Zn(ClO₄)₂, or any combination thereof in water.

In some embodiments, the cathode material comprises a manganese oxide, wherein the manganese oxide is not substantially soluble in the electrolyte. For example, the cathode material comprises manganese oxide having a chemical formula of Mn,ₓO_{y}, where x is greater than or equal to 1, and y is greater than or equal to 2. In other examples, the cathode material comprises manganese oxide having a chemical formula of Mn₃O₇.3H₂O, Mn₇O₁₄.3H₂O, Mn₄O₉.3H₂O, Mn₂O₄, Mn₄O₁₈.H₂O, or any combination thereof. And, in some embodiments, the cathode comprises manganese oxide having a predominant crystal structure of α-MnO₂, β-MnO₂, γ-MnO₂, δ-MnO₂, layered, or any combination thereof.

In other embodiments, the anode material comprises manganese oxide, wherein the manganese oxide is not substantially soluble in the electrolyte. In some examples, the anode material comprises manganese oxide having a chemical formula of MnₓO_{y} where x is greater than or equal to 1, and y is greater than or equal to 2. In other examples, the anode material comprises manganese oxide having a chemical formula of Mn₃O₇.3H₂O, Mn₇O₁₄.3H₂O, Mn₄O₉.3H₂O, Mn₂O₄, Mn₄O₁₈.H₂O, or any combination thereof. And, in some embodiments, the anode material comprises manganese oxide having a predominant crystal structure of α-MnO₂, β-MnO₂, γ-MnO₂, δ-MnO₂, layered, or any combination thereof.

In alternative embodiments, the cathode material comprises manganese oxide, the anode material comprises manganese oxide, and the oxidation state of the manganese in the cathode material is greater than the oxidation state of the manganese in the anode material when the cell has an SOC of at least about 90%. For example, the cathode material comprises manganese oxide, and the oxidation state of the manganese in the cathode material is about 4, when the cell has an SOC of at least about 90%. In other examples, the anode material comprises manganese oxide, and the oxidation state of the manganese in the anode material is about 2, when the cell has an SOC of at least about 90%.

In some embodiments, the cathode material comprises manganese oxide, the anode material comprises manganese oxide, and the oxidation state of the manganese in the cathode material is approximately equal to the oxidation state of the manganese in the anode material when the cell has an SOC of less than about 10%. For example, the cathode material comprises manganese oxide, the anode material comprises manganese oxide, and the oxidation state of the manganese in the cathode material and the manganese in the anode material is about 3 when the cell has an SOC of less than about 10%.

In some embodiments, the anode material, the cathode material, or both further comprises a carbon powder. For example, the anode material, the cathode material, or both further comprises about 15 wt % or less of the carbon powder by weight of the electrode material. In some instances, the carbon powder comprises acetylene black, furnace black, channel black, graphite, activated carbon, graphene, or any combination thereof.

In other embodiments, the anode material, the cathode material, or both further comprises an additive that stabilizes the crystal lattice structure of manganese oxide. In some instances, the additive comprises TiS₂, TiB₂, Bi₂O₃, or any combination thereof. In other instances, the additive is present at a concentration of about 20 wt % or less by weight of the electrode material.

Another aspect of the present invention provides a method of manufacturing an electrochemical cell comprising providing a cathode comprising a layered material; providing an anode comprising a metal; and providing an aqueous electrolyte comprising a divalent cation, wherein the divalent cation intercalates into the layered material when the cell discharges; and the divalent cation de-intercalates from the cathode material and deposits onto the anode material as a neutral metal when the cell charges.

In some implementations, the divalent cation is selected from Zn²⁺, Ca²⁺, Mg²⁺, Fe²⁺, or any combination thereof. For example, the divalent cation is Zn²⁺.

Some implementations further comprise dissolving ZnSO₄, Zn(CHO₂)₂, Zn(NO₃)₂, Zn(CO₂CH₃)₂, ZnCl₂, ZnBr₂, Zn(ClO₄)₂, or any combination thereof in water to generate the Zn²⁺ divalent cation.

In some implementations, the cathode comprises a layered material comprising a metal oxide, a mixed metal oxide, a metal sulfide, a zinc metal phosphate, a zinc metal oxide, or any combination thereof. For example, the cathode material comprises manganese oxide, vanadium oxide, manganese vanadium oxide, TiS₂, WO₂Cl₂, or any combination thereof. In other examples, the cathode comprises a metal oxide that undergoes a reduction in its oxidation state of 1 or more during the discharge of the electrochemical cell. And, in some instances, the cathode comprises manganese oxide having a chemical formula of MnₓO_{y} and x is greater than or equal to 1, and y is greater than or equal to 2. In some instances, the cathode comprises manganese vanadium oxide having a chemical formula of MnₓV_{z}O_{y}, where x is greater than or equal to 1, y is greater than or equal to 2, and z is greater than or equal to 1. In other instances, the cathode comprises manganese oxide having a chemical formula of MnO₂, Mn₅O₈, Mn₃O₇.3H₂O, Mn₇O₁₄.3H₂O, Mn₄O₉.3H₂O, Mn₂O₄, Mn₄O₁₈.H₂O, or any combination thereof. And, in some embodiments, the cathode comprises manganese oxide having a predominant crystal structure of α-MnO₂, β-MnO₂, γ-MnO₂, δ-MnO₂, layered, or any combination thereof. For example, the cathode comprises Mn₅O₈, and the Mn₅O₈ comprises a powder having a mean particle diameter of about 50 μm or less.

In some implementations, cathode further comprises carbon powder. For example, the cathode further comprises about 15 wt % or less of the carbon powder by weight of the electrode material. In other examples, the carbon powder comprises acetylene black, furnace black, channel black, graphite, activated carbon, graphene, or any combination thereof.

In some implementations, the cathode further comprises an additive that stabilizes the crystal lattice structure of manganese oxide. In some instances, the additive comprises TiS₂, TiB₂, Bi₂O₃, or any combination thereof. In other instances, the additive is present at a concentration of about 20 wt % or less by weight of the electrode material.

In some implementations, the anode material comprises a metal that undergoes an increase in its oxidation state of 1 or more during the discharge of the electrochemical cell. For example, the anode comprises zinc metal or magnesium metal.

In some implementations, the divalent cation is Zn²⁺, and the anode comprises zinc metal.

In some implementations, the cathode material, the anode material, or both is doped with Al, B, or any combination thereof.

In some implementations, the anode material, the cathode material, or both further comprises a binder. In some instances, the binder comprises polyacrylonitrile, polyvinyl alcohol, polyvinyl chloride, polyethylene oxide, polytetrafluoroethylene, polyvinylidene difluoride, polymethylmethacrylate, or any combination thereof. In other instances, the binder is present at a concentration of from about 3 wt % to about 15 wt % by weight of the electrode material.

Some implementations further comprise providing a cathode current collector, an anode current collector, or both. In some instances, the cathode current collector, the anode current collector, or both comprises one or more electrically conductive metals or an electrically conductive polymer material. In other instances, the cathode current collector, the anode current collector, or both comprises a woven material, a non-woven material, or a combination thereof. And, in some instances, the cathode current collector, the anode current collector, or both comprises a sheet of non-woven material that optionally comprises perforations.

Another aspect of the present invention provides a method of manufacturing an electrochemical cell comprising providing a cathode comprising a cathode material; providing an anode comprising an anode material; and providing an aqueous electrolyte comprising a divalent cation, wherein the cathode material and the anode material are not substantially soluble in the electrolyte, and the divalent cation intercalates into the cathode and the divalent cation de-intercalates from the anode when the cell discharges; and the divalent cation de-intercalates from the cathode and intercalates into the anode when the cell charges.

In some implementations, the electrolyte comprises a nearly neutral pH. For example, the electrolyte has a pH from about 6 to about 8 (e.g., from about 6.5 to about 7.5).

In other implementations, the divalent cation is selected from Zn²⁺, Ca²⁺, Mg²⁺, Fe²⁺, or any combination thereof. For example, the divalent cation is Zn²⁺.

Some implementations further comprise dissolving ZnSO₄, Zn(CHO₂)₂, Zn(NO₃)₂, Zn(CO₂CH₃)₂, ZnCl₂, ZnBr₂, Zn(ClO₄)₂, or any combination thereof in water to generate the Zn²⁺ divalent cation.

In other implementations, the anode material, the cathode material, or both comprises a metal oxide, a mixed metal oxide, a metal sulfide, a layered compound, a zinc metal phosphate, a zinc metal oxide, or any combination thereof. For example, the anode material, the cathode material, or both comprises manganese oxide, vanadium oxide, manganese vanadium oxide, TiS₂, WO₂Cl₂, or any combination thereof.

In some implementations, the cathode material comprises a metal oxide that undergoes a reduction in its oxidation state of 1 or more during the discharge of the electrochemical cell.

In other implementations, the anode material comprises a metal oxide that undergoes an increase in its oxidation state of 1 or more during the discharge of the electrochemical cell.

In some implementations, the cathode material, the anode material, or both comprises manganese oxide having a chemical formula of MnₓO_{y} and x is greater than or equal to 1, and y is greater than or equal to 2. In other implementations, the anode material, the cathode material, or both comprises manganese vanadium oxide having a chemical formula of MnₓV_{z}O_{y}, where x is greater than or equal to 1, and y is greater than or equal to 2, and z is greater than or equal to 1.

In alternative implementations, the cathode material, the anode material, or both comprises manganese oxide having a chemical formula of Mn₃O₇.3H₂O, Mn₇O₁₄.3H₂O, Mn₄O₉.3H₂O, Mn₂O₄, Mn₄O₁₈.H₂O, or any combination thereof. And, in some embodiments, the cathode material, the anode material, or both comprises manganese oxide having a predominant crystal structure of α-MnO₂, β-MnO₂, γ-MnO₂, δ-MnO₂, layered, or any combination thereof.

In some implementations, the cathode material comprises manganese oxide, the anode material comprises manganese oxide, and the oxidation state of the manganese in the cathode material is greater than the oxidation state of the manganese in the anode material, when the cell has an SOC of at least about 90%. For example, the cathode material comprises manganese oxide, and the oxidation state of the manganese in the cathode material is about 4, when the cell has an SOC of at least about 90%.

In other implementations, the anode material comprises manganese oxide, and the oxidation state of the manganese in the anode material is about 2, when the cell has an SOC of at least about 90%.

In some implementations, the cathode material comprises manganese oxide, the anode material comprises manganese oxide, and the oxidation state of the manganese in the cathode material is approximately equal to the oxidation state of the manganese in the anode material when the cell has an SOC of less than about 10%. For example, the cathode material comprises manganese oxide and the anode material comprises manganese oxide, and the oxidation state of the manganese in the cathode material and the anode material is about 3 when the cell has an SOC of less than about 10%.

In other implementations, the anode material, the cathode material, or both further comprises a carbon powder. In some instances, the anode material, the cathode material, or both further comprises about 15 wt % or less of the carbon powder by weight of the electrode material. In other instances, the carbon powder comprises acetylene black, furnace black, channel black, graphite, activated carbon, graphene, or any combination thereof.

In some implementations, the anode material, the cathode material, or both further comprises an additive that stabilizes the crystal lattice structure of manganese oxide. In some instances, the additive comprises TiS₂, TiB₂, Bi₂O₃, or any combination thereof. In other instances, the additive is present at a concentration of about 20 wt % or less by weight of the electrode material.

In other implementations, the anode material, the cathode material, or both further comprises a binder. In some instances, the binder comprises polyacrylonitrile, polyvinyl alcohol, polyvinyl chloride, polyethylene oxide, polytetrafluoroethylene, polyvinylidene difluoride, polymethylmethacrylate, or any combination thereof. In other instances, the binder is present at a concentration of from about 3 wt % to about 15 wt % by weight of the electrode material.

And, some implementations further comprise providing a cathode current collector, an anode current collector, or both. In some instances, the cathode current collector, the anode current collector, or both comprises one or more electrically conductive metals or an electrically conductive polymer material. In some instances, the cathode current collector, the anode current collector, or both comprises a woven material, a non-woven material, or a combination thereof. And, in other instances, the cathode current collector, the anode current collector, or both comprises a sheet of non-woven material that optionally comprises perforations.

### BRIEF DESCRIPTION OF THE DRAWINGS

FIGS. 1 and 2 graphically depict a charge profile for an exemplary electrochemical cell of the present invention.

FIGS. 3-5 are plots of current (Amps) vs. Potential (Volts) for several manganese oxide test cells of the present invention.

These figures are provided by way of example and are not intended to limit the scope of the invention.

### DETAILED DESCRIPTION

The present invention provides an electrochemical cell comprising an aqueous electrolyte formulated with a divalent cation that intercalates into a cathode upon discharge of the cell.

### I. Definitions

As used herein, the term “battery” encompasses electrical storage devices comprising one electrochemical cell (e.g., a button cell, a coin cell, or the like) or a plurality of electrochemical cells. A “secondary battery” is rechargeable, whereas a “primary battery” is not rechargeable. For secondary batteries of the present invention, a battery cathode is designated as the positive electrode during battery discharge and the negative electrode during battery charging. Accordingly, the anode is designated as the negative electrode during discharge, and as the positive electrode during charge.

As used herein, the terms “electrochemical cell” and “cell” are used interchangeably.

As used herein, the term “metal oxide” includes compounds that include at least one metal atom and at least one oxygen atom. ‘Metal oxides’ include “mixed metal oxides”, wherein the metal oxide comprises at least two metal atoms of different elements and at least one oxygen atom.

As used herein, the term “manganese oxide” refers to any manganese compound that includes one or more oxygen atoms in its coordination sphere. Examples of manganese oxide include MnO, MnO₂, Mn₂O₃, Mn₃O₄, Mn(OH)₂, Mn(OH)₄, MnO₂(OH)₂, Mn(OH)₃, MnOOH, Mn(ONa)₂, Mn(OK)₂, Mn(OLi)₂, Mn(ORb)₂, MnOONa, MnOOK, MnOOLi, MnOORb, ZnFeMnO₂, (MnFe)₂O₃, NiMnO₄, any hydrate thereof, or any combination thereof. In other examples, manganese oxide has the chemical formula MnₓO_{y} wherein x is greater than or equal to 1, and y is greater than or equal to 2. Some examples of manganese oxide have the chemical formula of MnO₂, Mn₅O₈, Mn₃O₇.3H₂O, Mn₇O₁₄.3H₂O, Mn₄O₉.3H₂O, Mn₂O₄, Mn₄O₁₈.H₂O, or any combination thereof. In other examples, the manganese oxide has a predominant crystal structure of α-MnO₂, β-MnO₂, γ-MnO₂, δ-MnO₂, layered, or any combination thereof. Note that ‘hydrates’ of manganese include hydroxides of manganese. The term ‘manganese oxide’ also includes any of the abovementioned species that are doped and/or coated with dopants and/or coatings that enhance one or more properties of the manganese.

As used herein, “vanadium oxide” refers to any vanadium compound having at least one oxygen atom in its coordination sphere. ‘Vanadium oxide’ includes oxides or hydroxide of vanadium, e.g., VO, VO₂, V₂O₃, V₂O₅, V₃O₇, V₄O₉, V₆O₁₃, V₄O₇, V₅O₉, V₆O₁₁, V₇O₁₃, V₈O₁₅, or any combination thereof.

As used herein, an “electrolyte” refers to a substance that behaves as an electrically conductive medium. For example, the electrolyte facilitates the mobilization of electrons and cations (e.g., divalent cations) in the cell. Electrolytes include aqueous electrolytes that are formulated with mixtures of materials such as aqueous solutions of metal salts (e.g., ZnSO₄, Zn(NO₃)₂, Zn(CO₂CH₃)₂, ZnCl₂, ZnBr₂, Zn(ClO₄)₂, or any combination thereof). Some electrolytes also comprise additives such as buffers. For example, an electrolyte comprises a buffer comprising a borate or a phosphate.

A “cycle” or “charge cycle” refers to a consecutive charge and discharge of a cell or a consecutive discharge and charge of a cell, either of which includes the duration between the consecutive charge and discharge or the duration between the consecutive discharge and charge. For example, a cell undergoes one cycle when, freshly prepared, it is discharged to about 100% of its DOD and re-charged to about 100% of its state of charge (SOC). In another example, a freshly prepared cell undergoes 2 cycles when the cell is: Cycle 1: discharged to about 100% of its DOD and re-charged to about 100% SOC; followed by Cycle 2: a second discharge to about 100% of its DOD and re-charged to about 100% SOC.

It is noted that this process may be repeated to subject a cell to as many cycles as is desired or practical.

For convenience, the polymer name “polyacrylonitrile” and its corresponding initials “PA” are used interchangeably as adjectives to distinguish polymers, solutions for preparing polymers, and polymer coatings. Use of these names and initials in no way implies the absence of other constituents. These adjectives also encompass substituted and co-polymerized polymers. A substituted polymer denotes one for which a substituent group, a methyl group, for example, replaces a hydrogen on the polymer backbone.

For convenience, the polymer name “polyvinyl alcohol” and its corresponding initials “PVA” are used interchangeably as adjectives to distinguish polymers, solutions for preparing polymers, and polymer coatings. Use of these names and initials in no way implies the absence of other constituents. These adjectives also encompass substituted and co-polymerized polymers.

For convenience, the polymer name “polyvinyl chloride” and its corresponding initials “PVC” are used interchangeably as adjectives to distinguish polymers, solutions for preparing polymers, and polymer coatings. Use of these names and initials in no way implies the absence of other constituents. These adjectives also encompass substituted and co-polymerized polymers.

For convenience, the polymer name “polyethylene oxide” and its corresponding initials “PEO” are used interchangeably as adjectives to distinguish polymers, solutions for preparing polymers, and polymer coatings. Use of these names and initials in no way implies the absence of other constituents. These adjectives also encompass substituted and co-polymerized polymers.

For convenience, the polymer name “polytetrafluoroethylene” and its corresponding initials “PTFE” are used interchangeably as adjectives to distinguish polymers, solutions for preparing polymers, and polymer coatings. Use of these names and initials in no way implies the absence of other constituents. These adjectives also encompass substituted and co-polymerized polymers. A substituted polymer denotes one for which a substituent group, a methyl group, for example, replaces a hydrogen on the polymer backbone.

For convenience, the polymer name “polyvinylidene difluoride” and its corresponding initials “PVD” are used interchangeably as adjectives to distinguish polymers, solutions for preparing polymers, and polymer coatings. Use of these names and initials in no way implies the absence of other constituents. These adjectives also encompass substituted and co-polymerized polymers.

For convenience, the polymer name “polymethylmethacrylate” and its corresponding initials “PMMA” are used interchangeably as adjectives to distinguish polymers, solutions for preparing polymers, and polymer coatings. Use of these names and initials in no way implies the absence of other constituents. These adjectives also encompass substituted and co-polymerized polymers.

As used herein, “Ah” refers to Ampere (Amp) Hour and is a scientific unit for the capacity of a battery or electrochemical cell. A derivative unit, “mAh” represents a milliamp hour and is 1/1000 of an Ah.

As used herein, an “anode” is an electrode through which (positive) electric current flows into a polarized electrical device. In a battery or galvanic cell, the anode is the negative electrode from which electrons flow during the discharging phase in the battery. The anode is also the electrode that undergoes chemical oxidation during the discharging phase. However, in secondary, or rechargeable, cells, the anode is the electrode that undergoes chemical reduction during the cell's charging phase. Anodes are formed from electrically conductive or semiconductive materials, e.g., metal oxides, metal sulfides, layered compounds, zinc-metal phosphates, zinc-metal oxides, or any combination thereof.

Anodes may have many configurations. For example, an anode may be configured from a conductive mesh or grid that is coated with one or more anode materials. In another example, an anode may be a solid sheet or bar of anode material.

As used herein, a “cathode” is an electrode from which (positive) electric current flows out of a polarized electrical device. In a battery or galvanic cell, the cathode is the positive electrode into which electrons flow during the discharging phase in the battery. The cathode is also the electrode that undergoes chemical reduction during the discharging phase. However, in secondary or rechargeable cells, the cathode is the electrode that undergoes chemical oxidation during the cell's charging phase. Cathodes are formed from electrically conductive or semiconductive materials, e.g., metal oxides, metal sulfides, layered compounds, zinc-metal phosphates, zinc-metal oxides, or any combination thereof.

Cathodes may also have many configurations. For example, a cathode may be configured from a conductive mesh that is coated with one or more cathode materials. In another example, a cathode may be a solid sheet or bar of cathode material.

As used herein, the term “Coulombic efficacy” refers to the number of Coulombs removed from a battery cell on discharge divided by the number of Coulombs that are added into the cell on charge.

As used herein, the term “electronic device” is any device that is powered by electricity. For example, and electronic device can include a portable computer, a portable music player, a cellular phone, a portable video player, global positioning satellite (“GPS”) navigation devices, or any device that combines the operational features thereof.

As used herein, the term “cycle life” is the maximum number of times a secondary battery can be cycled while retaining a capacity useful for the battery's intended use (e.g., the number of times a cell may be cycled until the cell's 100% SOC, i.e., its actual capacity, is less than 90% of its rated capacity (e.g., less than 85% of its rated capacity, about 90% of its rated capacity, or about 80% of its rated capacity). In some instances, ‘cycle life’ is the number of times a secondary battery or cell can be cycled until the cell's 100% SOC is at least about 60 percent of its rated capacity (e.g., at least about 70 percent of its rated capacity, at least about 80 percent of its rated capacity, at least 90 percent of its rated capacity, at least 95 percent of its rated capacity, about 90% of its rated capacity, or about 80% of its rated capacity).

As used herein, the symbol “M” denotes molar concentration.

As used herein, the term “oxide” applied to secondary batteries and secondary battery electrodes encompasses corresponding “hydroxide” species, which are typically present, at least under some conditions.

As used herein, the term, “powder” refers to a dry, bulk solid composed of a plurality of fine particles that may flow freely when shaken or tilted.

As used herein, the term, “mean diameter” or “mean particle diameter” refers to the diameter of a sphere that has the same volume/surface area ratio as a particle of interest.

As used herein, the terms “substantially stable” or “substantially inert” refer to a compound or component that remains substantially chemically unchanged in the presence of an aqueous electrolyte (e.g., aqueous divalent cations).

As used herein, “charge profile” refers to a graph of an electrochemical cell's voltage or capacity with time. A charge profile can be superimposed on other graphs such as those including data points such as charge cycles or the like.

As used herein, “resistivity” or “impedance” refers to the internal resistance of a cathode in an electrochemical cell. This property is typically expressed in units of Ohms or micro-Ohms.

As used herein, the terms “first” and/or “second” do not refer to order or denote relative positions in space or time, but these terms are used to distinguish between two different elements or components. For example, a first component does not necessarily proceed a second component in time or space; however, the first component is not the second component and vice versa. Although it is possible for a first component to precede a second component in space or time, it is equally possible that a second component precedes a first component in space or time.

As used herein, the term “nanometer” and “nm” are used interchangeably and refer to a unit of measure equaling 1×10⁻⁹ meters.

As used herein, the terms “analogous cathode” refer to a cathode of a pair of cathodes wherein the cathodes of the pair are substantially identical to each other (e.g., use substantially the same amount of cathode materials (e.g., manganese, binder, dopants, coatings, or any combination thereof); and/or using substantially the same methods of manufacturing) whose most significant difference is that one cathode of the pair is substantially free of stabilizing agent.

As used herein, the terms “battery capacity” or “capacity” refer to the mathematical product of a battery's discharge current and the time (in hours) during which the current is discharged.

As used herein, the terms “aggregate capacity” or “aggregate battery capacity” refers to the sum of a battery's capacities, i.e., the sum of the individual products of discharge current and the time during which the current is discharged after being discharged to about 100 percent depth of discharge (e.g., more than 97.5% depth of discharge, or more than 99% depth of discharge) over a course of one or more charge cycles.

As used herein, “depth of discharge” and “DOD” are used interchangeably to refer to the measure of how much energy has been withdrawn from a battery or cell, often expressed as a percentage of capacity, e.g., rated capacity. For example, a 100 Ah battery from which 30 Ah has been withdrawn has undergone a 30% depth of discharge (DOD).

As used herein, “state of charge” and “SOC” and used interchangeably to refer to the available capacity remaining in a battery, expressed as a percentage of the cell or battery's rated capacity.

The term “divalent cation” refers to an ion that lacks two electrons when compared to its neutral counterpart. Examples of divalent cations include Zn²⁺, Ca²⁺, Mg²⁺, Fe²⁺, or any combination thereof.

The term “intercalate” refers to a reversible insertion of a chemical species (e.g., a compound or ion (e.g., cation or anion)) between two other molecules.

The term “de-intercalate” refers to the expulsion of a chemical species from its location between two other molecules.

The term “layered material” refers to a material that possesses permanent or transient porosity within its crystalline or semi-crystalline structure. Examples of layered materials include some forms of metal oxides (e.g., manganese oxide or vanadium oxide) or metal sulfides (e.g., TiS₂).

### II. Electrochemical Cells

Electrochemical cells of the present invention comprise a cathode, an anode, and an aqueous electrolyte that comprises a divalent cation, wherein the divalent cation intercalates into the cathode when the cell is discharged.

While not being limited by theory, it is theorized that the electrochemical cells of the present invention employ a divalent cation intercalation mechanism, where divalent cations intercalate into the cathode from the aqueous electrolyte and the anode when the cell discharges. During cell charging or re-charging, the process is reversed and the cations deposit on the anode in as neutral species. Thus, the cathode material and the anode material reversibly, and with little or no physical change in their matrix structures, alternate between different oxidation states while divalent cations reversibly insert (intercalate) or deposit into the cathode or onto the anode.

### A. Cathodes

Cathodes that are useful in electrochemical cells of the present invention are substantially insoluble in the electrolyte and are intercalatable with respect to cations in an aqueous environment.

In some embodiments, the cathode comprises a layered material that comprises a metal oxide, mixed metal oxide, a metal sulfide, a zinc metal phosphate, a zinc metal oxide, or any combination thereof. For example, the layered material comprises manganese oxide, vanadium oxide, manganese vanadium oxide, TiS₂, WO₂Cl₂, or any combination thereof. In some examples, the layered material comprises a manganese oxide, wherein the manganese undergoes a reduction in its oxidation state of 1 or more when the cell is discharged. In other examples, the layered material comprises a manganese oxide, wherein the manganese undergoes an increase in its oxidation state of 1 or more when the cell is charged.

In some embodiments, the cathode comprises manganese oxide having a chemical formula of MnₓO_{y} where x is greater than or equal to 1, and y is greater than or equal to 2.

In some embodiments, the layered material comprises manganese oxide having a chemical formula of MnO₂, Mn₅O₈, Mn₃O₇.3H₂O, Mn₇O₁₄.3H₂O, Mn₄O₉.3H₂O, Mn₂O₄, Mn₄O₁₈.H₂O, or any combination thereof. In other embodiments, the cathode comprises manganese oxide having a predominant crystal structure of α-MnO₂, β-MnO₂, γ-MnO₂, δ-MnO₂, layered, or any combination thereof.

In some embodiments, the layered material comprises vanadium oxide having a chemical formula of VO, VO₂, V₂O₃, V₂O₅, V₃O₇, V₄O₉, V₆O₁₃, V₄O₇, V₅O₉, V₆O₁₁, V₇O₁₃, V₈O₁₅, or any combination thereof.

In some embodiments, the layered material comprises a combination of manganese and vanadium oxide (e.g., manganese vanadium oxide). For instance, the layered material comprises a material having a chemical formula of MnₓV_{z}O_{y}, wherein z is 1 or more, and x and y are as defined above.

In other embodiments, the layered material is doped with Al, B, or any combination thereof. For example, the layered material comprises a manganese oxide or manganese vanadium oxide that is doped with Al, B, or any combination thereof. In some instances, the layered material comprises manganese oxide, and the manganese oxide is doped with Al, B, or any combination thereof In another example, the cathode comprises manganese vanadium oxide that is doped with Al, B, or any combination thereof.

In some embodiments, the layered material of the cathode comprises a bulk material. In other embodiments, the layered material of the cathode comprises a powder. For example, the layered material comprises Mn₅O₈ that comprises a power having a mean particle diameter of about 50 μm or less (e.g., about 10 μm or less, about 5 μm or less, about 1 μm or less, about 0.5 μm or less, or 0.1 μm or less).

Cathodes of the present invention may optionally comprise additives such as dopants, coatings (e.g., a hydrophobic coatings (e.g., a polymer coating)), conductivity enhancers, stabilizers, binders, or any combination thereof.

1. Conductivity Enhancers

In one embodiment, the cathode comprises a conductivity enhancer that improves the electrical conductivity of the layered material. In some examples, the cathode further comprises a carbon powder. For instance, cathode comprises about 20 wt % or less (e.g., about 15 wt % or less, about 10 wt % or less, about 5 wt % or less, or about 1 wt % or less) of the carbon powder by weight of the cathode. In other examples, the carbon powder comprises acetylene black, furnace black, channel black, graphite, activated carbon, graphene, or any combination thereof.

2. Stabilizers

In another embodiment, the cathode further comprises a stabilizer that stabilizes the crystal lattice structure of the layered material. For example, the stabilizer stabilizes the crystal structure of manganese oxide. In some instances, the stabilizer comprises TiS₂, TiB₂, Bi₂O₃, or any combination thereof In other instances, the cathode comprises about 20 wt % or less (e.g., about 15 wt % or less, about 10 wt % or less, about 5 wt % or less, or about 1 wt % or less) of stabilizer by weight of the cathode.

3. Binders

In some embodiments, the cathode further comprises a binder. For example, the cathode comprises a binder comprising polyacrylonitrile, polyvinyl alcohol, polyvinyl chloride, polyethylene oxide, polytetrafluoroethylene, polyvinylidene difluoride, polymethylmethacrylate, or any combination thereof. In other examples, the cathode comprises from about 1 wt % to about 20 wt % of binder (e.g., from about 3 wt % to about 15 wt % ) by weight of the cathode.

4. Current Collectors and Supports

Cathodes of the present invention can optionally include additional structures or supports such as current collectors. In some embodiments, the cathode comprises a current collector. In some instances, the current collector comprises one or more electrically conductive metals (e.g., Ti, Cu, Fe, or a combination thereof) or an electrically conductive polymer material (e.g., polyacetylene, polyphenylene vinylene, polypyrrole, polythiophene, polyaniline, polyphenylene sulfide, or any combination thereof). In other instances, the current collector comprises a woven material, a non-woven material (e.g., a screen, grid, or fabric material), or a combination thereof. And, in some instances, the current collector comprises a sheet of non-woven material that optionally comprises perforations.

### B. Electrolytes

Electrolytes useful in electrochemical cells of the present invention readily dissolve some metal salts to generate divalent cations in solution (e.g., an aqueous solution).

In some embodiments, the electrolyte is substantially free of alkaline earth metal hydroxides (e.g., NaOH, KOH, or the like). In these embodiments, the electrolyte comprises less than 0.1 wt % of an alkaline earth metal hydroxide by weight of electrolyte.

In some embodiments, the electrolyte comprises a divalent cation (e.g., a divalent metal cation). In some examples, the divalent cation is selected from Zn²⁺, Ca²⁺, Mg²⁺, Fe²⁺, or any combination thereof. For instance, the divalent cation is Zn²⁺. In some electrolytes, the Zn²⁺ divalent cation is generated upon the dissolution of ZnSO₄, Zn(CHO₂)₂, Zn(NO₃)₂, Zn(CO₂CH₃)₂, ZnCl₂, ZnBr₂, Zn(ClO₄)₂, or any combination thereof in water. In some embodiments, the electrolyte further comprises the salt counter ion to Zn²⁺.

In some embodiments, the electrolyte comprises a nearly neutral pH. For example, the electrolyte has a pH from about 6 to about 8 (e.g., from about 6.5 to about 7.5 or from about 6.7 to about 7.3).

In some embodiments, the aqueous electrolyte has a pH that is slightly acidic. For example, the electrolyte has a pH of from about 3 to about 6.

In some embodiments, the electrolyte comprises one or more metal salts (e.g., zinc metal salts) with a concentration below saturation. For example, the concentration of the metal salt may be between about 1 mole per kilogram of solution and 2 moles per kilogram of solution.

Electrolytes of the present invention may optionally contain additives such as buffers, surfactants, polymers, or the like.

### C. Exemplary Electrochemical Cell No. 1

One aspect of the present invention provides an electrochemical cell comprising an aqueous electrolyte comprising a divalent cation; a cathode comprising a layered material; and an anode comprising a metal, wherein the divalent cation intercalates into the layered material when the cell discharges; and the divalent cation de-intercalates from the cathode material and deposits onto the anode as a neutral metal when the cell charges.

1. Cathodes

Cathodes useful in exemplary electrochemical cell no. 1 are as described above.

2. Electrolytes

Electrolytes useful in exemplary electrochemical cell no. 1 are as described above.

3. Anodes

Anodes useful in exemplary electrochemical cell no. 1 comprise a metal. In some embodiments, the anode comprises zinc, magnesium, or a combination thereof. For example, the anode comprises zinc.

In some embodiments, the metal comprises a bulk material. In other embodiments, the metal comprises a powder. For example, the anode comprises zinc powder having a mean particle diameter of about 50 μm or less (e.g., about 10 μm or less, about 5 μm or less, about 1 μm or less, about 0.5 μm or less, or 0.1 μm or less).

In other embodiments, the anode comprises a metal, and a portion of the metal transforms into a divalent cation when the cell is discharged.

In some embodiments, the anode metal is a neutral form of the divalent cation. For example, the anode comprises zinc metal, and the divalent cation is Zn²⁺. In other embodiments, the anode metal is exclusive of the neutral form of the divalent cation. For example, the anode comprises zinc metal, and the divalent cation is Mg²⁺.

Anodes useful in this exemplary cell may optionally comprise a binder. For example, the anode further comprises a binder, and the binder comprises polyacrylonitrile, polyvinyl alcohol, polyvinyl chloride, polyethylene oxide, polytetrafluoroethylene, polyvinylidene difluoride, polymethylmethacrylate, or any combination thereof. In other examples, the anode comprises from about 1 wt % to about 20 wt % (e.g., from about 3 wt % to about 15 wt % ) of binder by weight of the anode.

In some embodiments, the anode comprises a current collector. Current collectors that are useful for combination with these anodes are as described above.

One exemplary electrochemical cell of the present invention comprises an aqueous electrolyte comprising a divalent cation comprising Zn²⁺, Mg²⁺, or a combination thereof; a cathode comprising manganese oxide; and an anode comprising zinc metal, magnesium metal, or a combination thereof, wherein the aqueous electrolyte has a nearly neutral pH, the divalent cation intercalates into the cathode when the cell discharges; and the divalent cation deposits onto the anode as a neutral metal when the cell charges.

### D. Exemplary Electrochemical Cell No. 2

Another aspect of the present invention provides an electrochemical cell comprising an aqueous electrolyte comprising a divalent cation; a cathode comprising a cathode material; and an anode comprising an anode material, wherein the divalent cation intercalates into the cathode material and de-intercalates from the anode material upon discharge of the electrochemical cell; and the divalent cation de-intercalates from the cathode material and intercalates into the anode material when the cell is charged or recharged.

1. Electrolytes

Electrolytes useful in exemplary electrochemical cell no. 2 are as described above.

2. Electrodes (Anodes and Cathodes)

Electrodes useful in these exemplary electrochemical cells are not substantially soluble in the aqueous electrolyte. Furthermore, these electrodes are susceptible to reversible intercalation by a divalent cation in an aqueous environment.

In some embodiments, the anode material, the cathode material, or both comprises a layered material. For example, the anode material, the cathode material, or both comprises metal oxide, a mixed metal oxide, a metal sulfide, a zinc metal phosphate, a zinc metal oxide, or any combination thereof. In some instances, the anode material, the cathode material, or both comprises manganese oxide, vanadium oxide, manganese vanadium oxide, TiS₂, WO₂Cl₂, or any combination thereof In other examples, the cathode material comprises a metal oxide that undergoes a reduction in its oxidation state of 1 or more during the discharge of the electrochemical cell. And, in some examples, the anode material comprises a metal oxide that undergoes an increase in its oxidation state of 1 or more during the discharge of the electrochemical cell.

In some embodiments, the cathode material comprises a manganese oxide, wherein the manganese oxide is not substantially soluble in the electrolyte. For example, the cathode material comprises manganese oxide having a chemical formula of MnₓO_{y} where x is greater than or equal to 1, and y is greater than or equal to 2. In other examples, the cathode material comprises manganese oxide having a chemical formula of MnO₂, Mn₅O₈, Mn₃O₇.3H₂O, Mn₇O₁₄.3H₂O, Mn₄O₉.3H₂O, Mn₂O₄, Mn₄O₁₈.H₂O, or any combination thereof. And, in some embodiments, the cathode material comprises manganese oxide having a predominant crystal structure of α-MnO₂, β-MnO₂, γ-MnO₂, δ-MnO₂, layered, or any combination thereof.

In some embodiments, the cathode material comprises manganese vanadium oxide having a chemical formula of MnₓV_{z}O_{y}, where x is greater than or equal to 1, and y is greater than or equal to 2, and z is greater than or equal to 1.

In some embodiments, the anode material comprises a manganese oxide, wherein the manganese oxide is not substantially soluble in the electrolyte. For example, the anode material comprises manganese oxide having a chemical formula of MnₓO_{y} where x is greater than or equal to 1, and y is greater than or equal to 2. In some embodiments, the anode material comprises manganese vanadium oxide having a chemical formula of MnₓV_{z}O_{y}, where x is greater than or equal to 1, and y is greater than or equal to 2, and z is greater than or equal to 1. In other examples, the anode material comprises manganese oxide having a chemical formula of MnO₂, Mn₅O₈, Mn₃O₇.3H₂O, Mn₇O₁₄.3H₂O, Mn₄O₉.3H₂O, Mn₂O₄, Mn₄O₁₈.H₂O, or any combination thereof. And, in some embodiments, the anode material comprises manganese oxide having a predominant crystal structure of α-MnO₂, β-MnO₂, γ-MnO₂, δ-MnO₂,layered, or any combination thereof.

In other embodiments, the cathode material comprises manganese oxide, the anode material comprises manganese oxide, and the oxidation state of the manganese in the cathode material is greater than the oxidation state of the manganese in the anode material when the cell has an SOC of at least about 90% (e.g., at least about 95% or at least about 99%). For example, the cathode material comprises manganese oxide, and the oxidation state of the manganese in the cathode material is about 4, when the cell has an SOC of at least about 90% (e.g., at least about 95% or at least about 99%). In other examples, the anode material comprises manganese oxide, and the oxidation state of the manganese in the anode material is about 2, when the cell has an SOC of at least about 90% (e.g., at least about 95% or at least about 99%).

In some embodiments, the cathode material comprises manganese oxide, the anode material comprises manganese oxide, and the oxidation state of the manganese in the cathode material is approximately equal to the oxidation state of the manganese in the anode material when the cell has an SOC of less than about 10% (e.g., less than about 7.5%, less than about 5%, or less than about 7.5%). For example, the cathode material comprises manganese oxide and the anode material comprises manganese oxide, and the oxidation state of the manganese in the cathode material and the manganese in the anode material is about 3 when the cell has an SOC of less than about 10% (e.g., less than about 7.5%, less than about 5%, or less than about 7.5%).

Electrodes (e.g., cathodes and/or anodes) useful in this exemplary electrochemical cell may optionally comprise additives such as surfactants, binders, stabilizers, conductivity enhancers (e.g., carbon powder), or other optional additives. For example, the anode material, the cathode material, or both further comprises a carbon powder. For example, the anode material, the cathode material, or both further comprises about 15 wt % or less (e.g., about 12 wt % or less, about 10 wt % or less, or about 5 wt % or less) of the carbon powder by weight of the electrode material. In some instances, the carbon powder comprises acetylene black, furnace black, channel black, graphite, activated carbon, graphene, or any combination thereof.

In alternative embodiments, the anode material, the cathode material, or both further comprises an additive that stabilizes the crystal lattice structure of manganese oxide. In some examples, the additive comprises TiS₂, TiB₂, Bi₂O₃, or any combination thereof. In other examples, the additive is present at a concentration of about 20 wt % or less (e.g., about 15 wt % or less, about 15 wt % or less, or about 10 wt % or less) by weight of the electrode material.

And, in some embodiments, the anode material, the cathode material, or both further comprises a binder. In some instances, the binder comprises polyacrylonitrile, polyvinyl alcohol, polyvinyl chloride, polyethylene oxide, polytetrafluoroethylene, polyvinylidene difluoride, polymethylmethacrylate, or any combination thereof. In other instances, the binder is present at a concentration of from about 3 wt % to about 15 wt % (e.g., from about 4 wt % to about 12 wt % or from about 5 wt % to about 10 wt % ) by weight of the electrode material (i.e., the cathode material and/or the anode material).

In other embodiments, the anode, the cathode, or both further comprises a current collector. In some instances, the current collector comprises one or more electrically conductive metals (e.g., Ti, Cu, Fe, or a combination thereof) or an electrically conductive polymer material (e.g., polyacetylene, polyphenylene vinylene, polypyrrole, polythiophene, polyaniline, polyphenylene sulfide, or any combination thereof). In other instances, the current collector comprises a woven material, a non-woven material, or a combination thereof. For example, the current collector comprises a sheet or film of non-woven material that optionally comprises perforations.

In some embodiments, the anode material, the cathode material, or both are doped with Al, B, or any combination thereof.

Another aspect of the present invention provides an electrochemical cell comprising an aqueous electrolyte comprising Zn²⁺; a cathode comprising manganese oxide; and an anode comprising manganese oxide, wherein the Zn²⁺ intercalates into the cathode and de-intercalates from the anode upon discharge of the electrochemical cell; and the Zn²⁺ de-intercalates into the cathode and intercalates into the anode when the cell is charged.

### III. Methods of Manufacturing an Electrochemical Cell

### A. Methods of Manufacturing Exemplary Electrochemical Cell No. 1

Another aspect of the present invention provides a method of manufacturing an electrochemical cell comprising providing a cathode comprising a layered material; providing an anode comprising a metal; and providing an aqueous electrolyte comprising a divalent cation, wherein the divalent cation intercalates into the layered material when the cell discharges; and the divalent cation de-intercalates from the cathode material and deposits onto the anode material as a neutral metal when the cell charges.

In some implementations, the divalent cation is selected from Zn²⁺, Ca²⁺, Mg²⁺, Fe²⁺, or any combination thereof.

In some implementations, the divalent cation is Zn²⁺.

Some implementations further comprise dissolving ZnSO₄, Zn(CHO₂)₂, Zn(NO₃)₂, Zn(CO₂CH₃)₂, ZnCl₂, ZnBr₂, Zn(ClO₄)₂, or any combination thereof in water to generate the Zn²⁺ divalent cation.

In some implementations, the electrolyte comprises a nearly neutral pH. For example, the electrolyte has a pH from about 6 to about 8 (e.g., from about 6.5 to about 7.5).

In some implementations, the cathode material comprises a layered material comprising a metal oxide, a mixed metal oxide, a metal sulfide, a zinc metal phosphate, a zinc metal oxide, or any combination thereof.

In some implementations, the cathode material comprises manganese oxide, vanadium oxide, manganese vanadium oxide, TiS₂, WO₂Cl₂, or any combination thereof.

In some implementations, the cathode material comprises a metal oxide that undergoes a reduction in its oxidation state of 1 or more during the discharge of the electrochemical cell.

In some implementations, the cathode comprises manganese oxide having a chemical formula of MnₓO_{y} and x is greater than or equal to 1, and y is greater than or equal to 2.

In some implementations, the cathode comprises manganese vanadium oxide having a chemical formula of MnₓV_{z}O_{y}, where x is greater than or equal to 1, and y is greater than or equal to 2, and z is greater than or equal to 1.

In some implementations, the cathode comprises manganese oxide having a chemical formula of MnO₂, Mn₅O₈, Mn₃O₇.3H₂O, Mn₇O₁₄.3H₂O, Mn₄O₉.3H₂O, Mn₂O₄, Mn₄O₁₈.H₂O, or any combination thereof. And, in some implementations, the cathode comprises manganese oxide having a predominant crystal structure of α-MnO₂, β-MnO₂, γ-MnO₂, δ-MnO₂, layered, or any combination thereof.

In some implementations, the cathode comprises Mn₅O₈, and the Mn₅O₈ comprises a powder having a mean particle diameter of about 50 μm or less (e.g., about 10 μm or less, about 5 μm or less, about 1 μm or less, about 0.5 μm or less, or 0.1 μm or less).

In some implementations, the cathode is doped with Al, B, or any combination thereof.

In some implementations, the cathode further comprises carbon powder.

In some implementations, the cathode further comprises about 15 wt % or less of the carbon powder by weight of the electrode material.

In some implementations, the carbon powder comprises acetylene black, furnace black, channel black, graphite, activated carbon, graphene, or any combination thereof.

In some implementations, the cathode further comprises a stabilizer that stabilizes the crystal lattice structure of manganese oxide.

In some implementations, the additive comprises TiS₂, TiB₂, Bi₂O₃, or any combination thereof.

In some implementations, the additive is present at a concentration of about 20 wt % or less (e.g., about 15 wt % or less, about 10 wt % or less, about 5 wt % or less, or about 1 wt % or less) of stabilizer by weight of the cathode.

In some implementations, the anode material comprises a metal that undergoes an increase in its oxidation state of 1 or more during the discharge of the electrochemical cell.

In some implementations, the anode comprises zinc metal or magnesium metal.

In some implementations, the divalent cation is Zn²⁺, and the anode comprises zinc metal.

In some implementations, the divalent cation is Mg²⁺, and the anode comprises magnesium metal.

In some implementations, the anode, the cathode, or both further comprises a binder.

In some implementations, the binder comprises polyacrylonitrile, polyvinyl alcohol, polyvinyl chloride, polyethylene oxide, polytetrafluoroethylene, polyvinylidene difluoride, polymethylmethacrylate, or any combination thereof.

In some implementations, the binder is present at a concentration of from about 1 wt % to about 20 wt % of binder (e.g., from about 3 wt % to about 15 wt %) by weight of the electrode.

Some implementations further comprise providing a cathode current collector, an anode current collector, or both.

In some embodiments, the cathode current collector, the anode current collector, or both comprises one or more electrically conductive metals or an electrically conductive polymer material, as described above.

In some embodiments, the cathode current collector, the anode current collector, or both comprises a woven material, a non-woven material, or a combination thereof.

In some embodiments, the cathode current collector, the anode current collector, or both comprises a sheet of non-woven material that optionally comprises perforations.

### B. Methods of Manufacturing Exemplary Electrochemical Cell No. 2

Another aspect of the present invention provides a method of manufacturing an electrochemical cell comprising providing a cathode comprising a cathode material; providing an anode comprising an anode material; and providing an aqueous electrolyte comprising a divalent cation, wherein the cathode material and the anode material are not substantially soluble in the electrolyte; the divalent cation intercalates into the cathode and de-intercalates from the anode when the cell discharges; and the divalent cation de-intercalates from the cathode and intercalates into the anode when the cell charges.

In some implementations, the divalent cation is selected from Zn²⁺, Ca²⁺, Mg²⁺, Fe²⁺, or any combination thereof. For example, the divalent cation is Zn²⁺.

Some implementations further comprise dissolving ZnSO₄, Zn(CHO₂)₂, Zn(NO₃)₂, Zn(CO₂CH₃)₂, ZnCl₂, ZnBr₂, Zn(ClO₄)₂, or any combination thereof in water to generate the Zn²⁺ divalent cation.

In other implementations, the anode material, the cathode material, or both comprises a metal oxide, a mixed metal oxide, a metal sulfide, a zinc metal phosphate, a zinc metal oxide, or any combination thereof. For example, the anode material, the cathode material, or both comprises manganese oxide, vanadium oxide, manganese vanadium oxide, TiS₂, WO₂Cl₂, or any combination thereof.

In some implementations, the cathode material comprises a metal oxide that undergoes a reduction in its oxidation state of 1 or more during the discharge of the electrochemical cell.

In other implementations, the anode material comprises a metal oxide that undergoes an increase in its oxidation state of 1 or more during the discharge of the electrochemical cell.

In some implementations, the cathode material, the anode material, or both comprises manganese oxide having a chemical formula of MnₓO_{y} and x is greater than or equal to 1, and y is greater than or equal to 2. In some implementations, the layered material comprises manganese vanadium oxide having a chemical formula of MnₓV_{z}O_{y}, where x is greater than or equal to 1, and y is greater than or equal to 2, and z is greater than or equal to 1.

In alternative implementations, the cathode material, the anode material, or both comprises manganese oxide having a chemical formula of Mn₃O₇.3H₂O, Mn₇O₁₄.3H₂O, Mn₄O₉.3H₂O, Mn₂O₄, Mn₄O₁₈.H₂O, or any combination thereof. And, in some implementations, the anode material, the cathode material, or both comprises manganese oxide having a predominant crystal structure of α-MnO₂, β-MnO₂, γ-MnO₂, δ-MnO₂, layered, or any combination thereof.

In some implementations, the cathode material comprises manganese oxide, the anode material comprises manganese oxide, and the oxidation state of the manganese in the cathode material is greater than the oxidation state of the manganese in the anode material when the cell has an SOC of at least about 90%. For example, the cathode material comprises manganese oxide, and the oxidation state of the manganese in the cathode material is about 4, when the cell has an SOC of at least about 90%. In other implementations, the anode material comprises manganese oxide, and the oxidation state of the manganese in the anode material is about 2, when the cell has an SOC of at least about 90%.

In some implementations, the cathode material comprises manganese oxide, the anode material comprises manganese oxide, and the oxidation state of the manganese in the cathode material is approximately equal to the oxidation state of the manganese in the anode material when the cell has an SOC of less than about 10%. For example, the cathode material comprises manganese oxide, the anode material comprises manganese oxide, and the oxidation state of the manganese in the cathode material and the anode material is about 3 when the cell has an SOC of less than about 10%.

In other implementations, the anode material, the cathode material, or both further comprises a carbon powder. In some instances, the anode material, the cathode material, or both further comprises about 15 wt % or less of the carbon powder by weight of the electrode material. In other instances, the carbon powder comprises acetylene black, furnace black, channel black, graphite, activated carbon, graphene, or any combination thereof.

In some implementations, the anode material, the cathode material, or both further comprises an additive that stabilizes the crystal lattice structure of manganese oxide. In some instances, the additive comprises TiS₂, TiB₂, Bi₂O₃, or any combination thereof. In other instances, the additive is present at a concentration of about 20 wt % or less by weight of the electrode material.

In some implementations, the anode material, the cathode material, or both is doped with Al, B, or any combination thereof.

In other implementations, the anode material, the cathode material, or both further comprises a binder. In some instances, the binder comprises polyacrylonitrile, polyvinyl alcohol, polyvinyl chloride, polyethylene oxide, polytetrafluoroethylene, polyvinylidene difluoride, polymethylmethacrylate, or any combination thereof. In other instances, the binder is present at a concentration of from about 3 wt % to about 15 wt % by weight of the electrode material.

And, some implementations further comprise providing a cathode current collector, an anode current collector, or both. In some instances, the cathode current collector, the anode current collector, or both comprises one or more electrically conductive metals or an electrically conductive polymer material. In some instances, the cathode current collector, the anode current collector, or both comprises a woven material, a non-woven material, or a combination thereof. And, in other instances, the cathode current collector, the anode current collector, or both comprises a sheet of non-woven material that optionally comprises perforations.

### IV. Examples

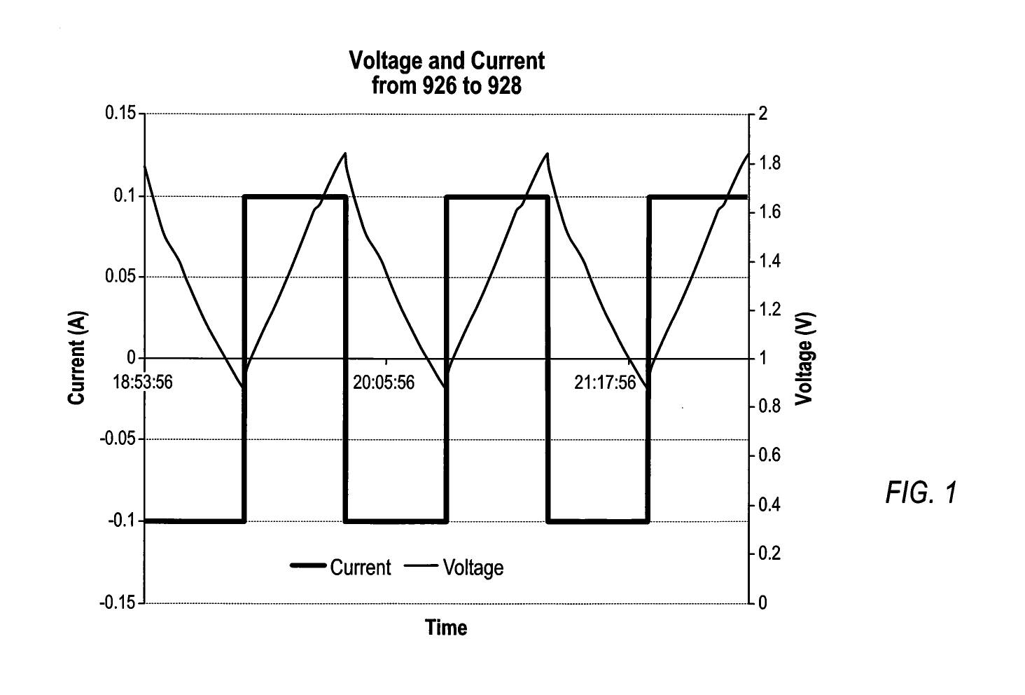

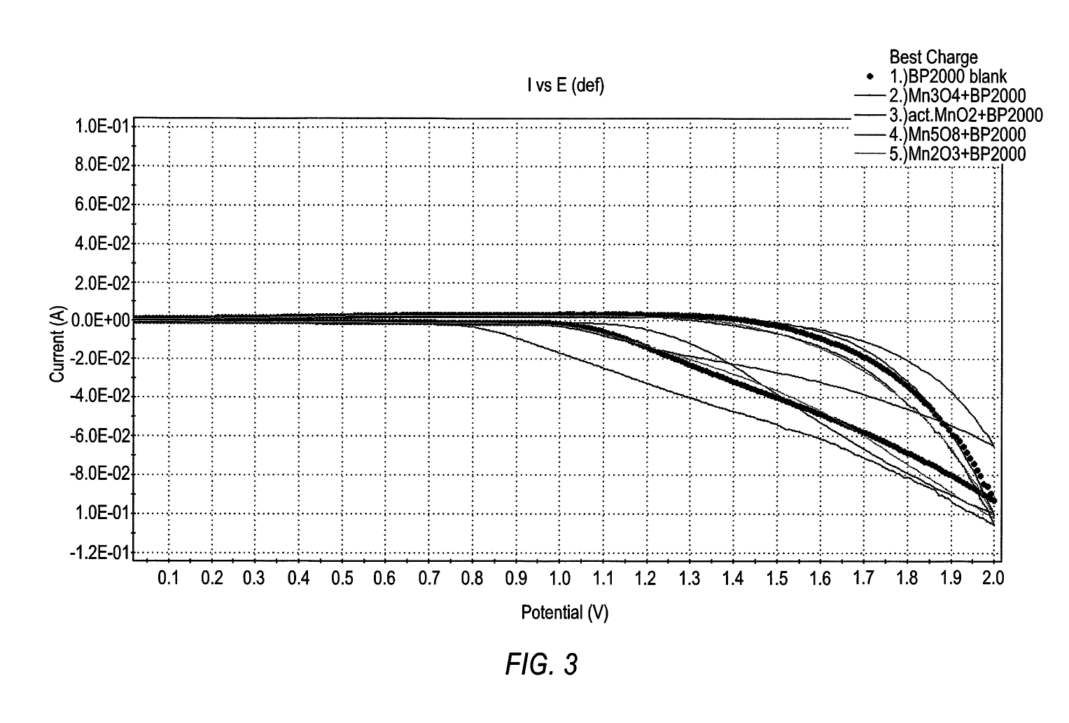

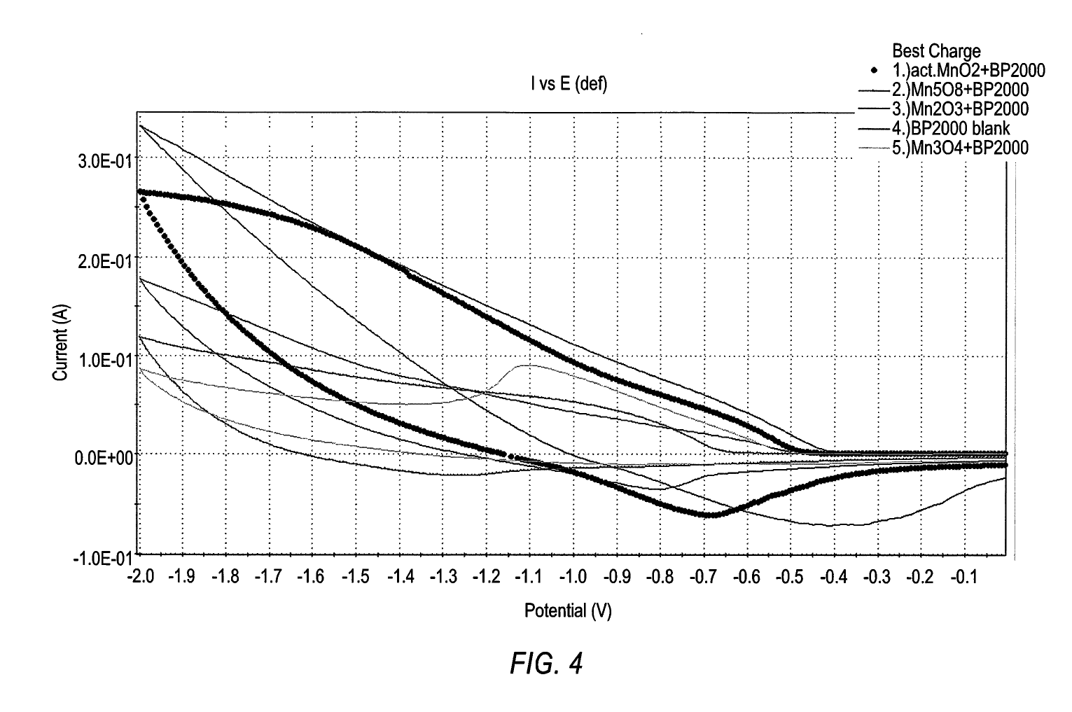

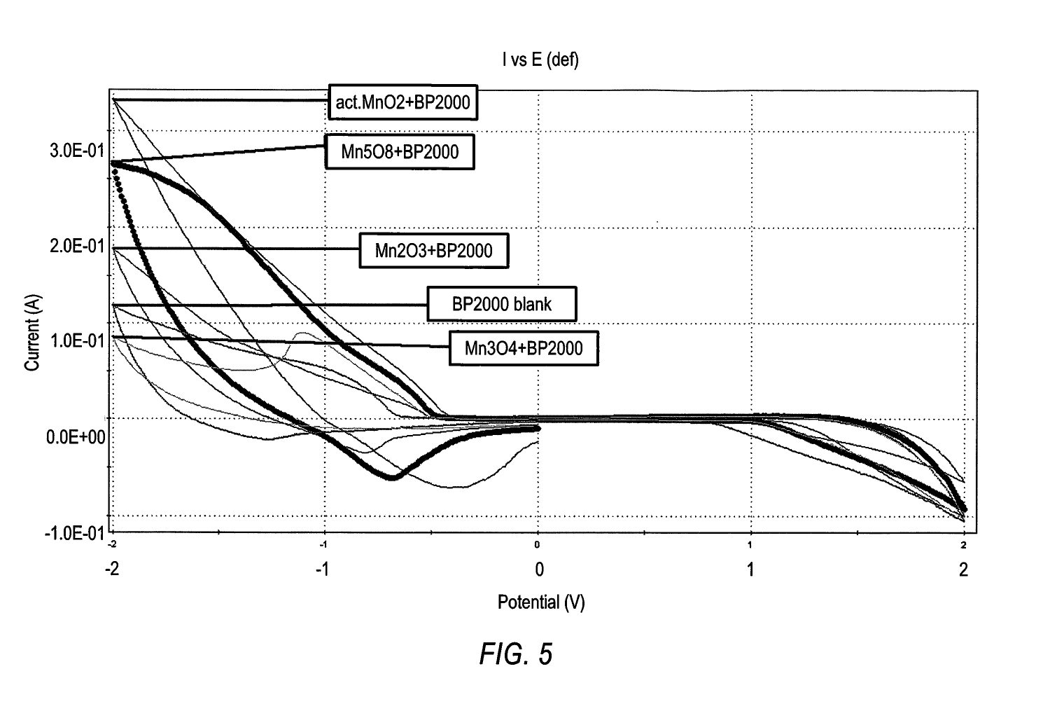

Referring to FIGS. 1-5, test cells were prepared and cycled as described below. The manganese oxide test cells were effectively charged and discharged over 1000 times with high Coulombic efficiency and with little loss in ampere-hour cell capacity.

The ˜100 cm² test cells included an anode formed from zinc metal. The ˜3″×6″ zinc anodes were generally prepared by electrochemically plating zinc metal on thin Ti sheets using aqueous solutions of ZnCl₂ and NH₄Cl.

The cathodes of the test cell were formed from manganese oxide and carbon black (Black Pearls 2000, commercially available from the Cabot Corp.). The cathode of test cell 1 was formed with MnO₂ and carbon black; the cathode of test cell 2 was formed with Mn₅O₈ and carbon black; the cathode of test cell 3 was formed with Mn₂O₃ and carbon black; the cathode of test cell 4 was formed with carbon black; and the cathode of test cell 5 was formed with Mn₃O₄ and carbon black. Cathodes were typically fabricated by blending 30% manganese oxide (e.g., MnO, Mn₂O₃, Mn₃O₄, or Mn₅O₈), 50% Black Pearls 2000 carbon black (a high surface area carbon black), and 20% PTFE (as a binder) and pressing this mixture onto a titanium metal screen current collector. Test cell 4 included 80% Black Pearls 2000 and 20% PTFE. The manganese oxide was prepared using standard procedures. For example, Mn₅O₈, was prepared by mixing an aqueous solution of manganese nitrate (16.7 g in 150 ml of H₂O) and an aqueous solution of NaOH (4.8 g NaOH in 50 ml of H₂O) and adding this to an aqueous solution of cetyl-trimethylammonium bromide (67 g in 150 ml of H₂O). The resulting mixture was heated to 75° C. and stirred for 1 hr. The obtained gel was transferred to an oven and heated for 12 h at 75° C. The solid reside was filtered, washed with di water, and calcined at 500° C. for 6 hours.

The electrolyte used in the test cells was generally formulated as an aqueous solution of 20% NH₄Cl, 10% ZnCl₂, and 5% LiCl.

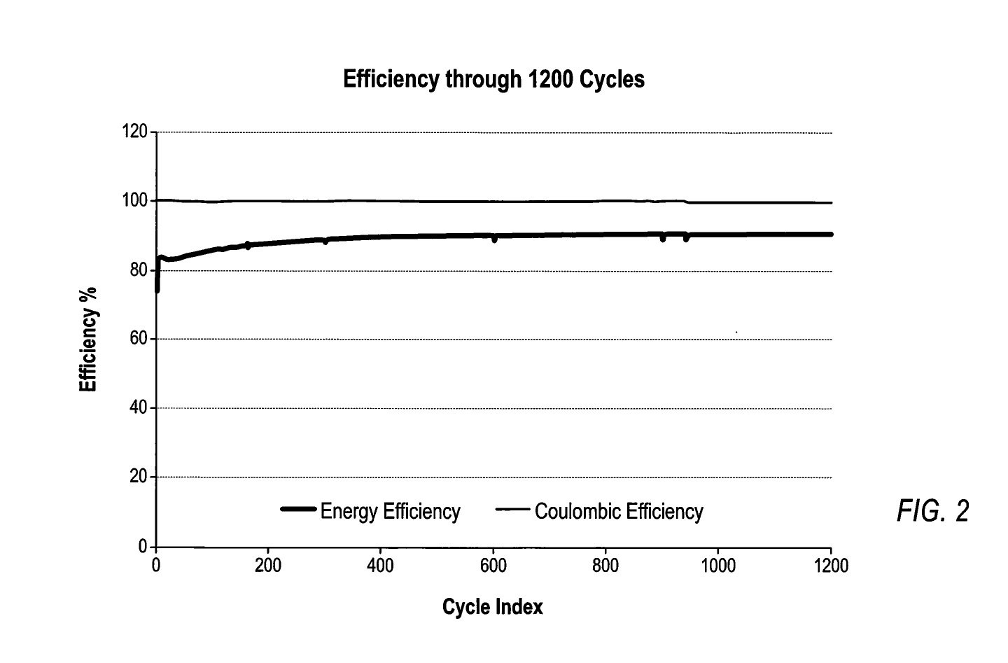

FIG. 1 shows room temperature, galvanostatic voltage-time profiles for the 926th, 927th, and 928th cycles of a 100 cm² Zn(s) /Mn₅O₈(s) test cell, i.e., test cell 2. The constant current load (shown as square waves with their axis on the left side of this figure) was 0.1 A during both cell discharge and cell charge. Cell voltage profiles (with their axis shown on the right side of this figure) ranged from 1.85V down to a cutoff of 0.9V during the 0.6 hour discharge and charge. Since a cell discharge rate of nC corresponds to a full cell discharge in 1/n hours, this cell discharge/charge rate corresponds to 1.66 C. At the illustrated 926th cycle, this cell delivered 104 mAh/g Mn₅O₈ at a current density of 208 mA/g Mn₅O₈. As shown below in FIG. 2, cell capacities for this cell, i.e., test cell 2, remained substantially unchanged for ˜1200 cycles.

FIG. 2 above shows Coulombic efficiencies (upper curve) and energy efficiencies (lower curve) for test cell 2 as a function of cycle number for the first 1200 discharge charge cycles. Coulombic efficiencies approached 100% while energy efficiencies, which initially were ˜80%, slowly rose to >90%. Electrochemical activity of this cell demonstrates the adequate charge discharge cyclic performance of this zinc aqueous reversible system.

### OTHER EMBODIMENTS

All publications and patents referred to in this disclosure are incorporated herein by reference to the same extent as if each individual publication or patent application were specifically and individually indicated to be incorporated by reference. Should the meaning of the terms in any of the patents or publications incorporated by reference conflict with the meaning of the terms used in this disclosure, the meaning of the terms in this disclosure are intended to be controlling. Furthermore, the foregoing discussion discloses and describes merely example embodiments of the present invention. One skilled in the art will readily recognize from such discussion and from the accompanying drawings and claims, that various changes, modifications and variations can be made therein without departing from the spirit and scope of the invention as defined in the following claims.

What is claimed is:

1. An electrochemical cell comprising:
an aqueous electrolyte comprising a divalent cation;
a cathode comprising a layered material; and
an anode comprising a metal,
wherein the divalent cation intercalates into the layered material when the cell discharges; and the divalent cation de-intercalates from the cathode material and deposits onto the anode material as a neutral metal when the cell charges.

2. The electrochemical cell of claim 1, wherein the divalent cation is selected from Zn²⁺, Ca²⁺, Mg²⁺, Fe²⁺, or any combination thereof.

3. The electrochemical cell of either of claim 1 or 2, wherein the divalent cation is Zn²⁺.

4. The electrochemical cell of claim 3, wherein the aqueous electrolyte further comprises SO₄²⁻, CHO⁻, NO₃⁻, CO₂CH₃⁻, Cl⁻, ClO₄⁻, or any combination thereof.

5. The electrochemical cell of any one of claims 1-4, wherein the electrolyte has a pH that is approximately neutral.

6. The electrochemical cell of any one of claims 1-5, wherein the electrolyte has a pH of from about 6 to about 8.

7. The electrochemical cell of any one of claims 1-4, wherein the electrolyte has a pH of from about 3 to about 6.

8. The electrochemical cell of any one of claims 1-7, wherein the layered material comprises a metal oxide, a mixed metal oxide, a metal sulfide, a zinc metal phosphate, a zinc metal oxide, or any combination thereof.

9. The electrochemical cell of claim 8, wherein the layered material comprises manganese oxide, vanadium oxide, manganese vanadium oxide, TiS₂, WO₂Cl₂, or any combination thereof.

10. The electrochemical cell of any one of claims 1-9, wherein the layered material comprises manganese oxide that undergoes a reduction in its oxidation state of 1 or more during the discharge of the electrochemical cell.

11. The electrochemical cell of claim 10, wherein the cathode material comprises manganese oxide having a chemical formula of MnₓO_{y} where x is greater than or equal to 1, and y is greater than or equal to 2.

12. The electrochemical cell of claim 9, wherein the cathode material comprises manganese vanadium oxide having a chemical formula of MnₓV_{z}O_{y}, where x is greater than or equal to 1, y is greater than or equal to 2, and z is greater than or equal to 1.

13. The electrochemical cell of claim 9, wherein the layered material comprises manganese oxide having a chemical formula of MnO₂, Mn₅O₈, Mn₃O₇.3H₂O, Mn₇O₁₄.3H₂O, Mn₄O₉.3H₂O, Mn₂O₄, Mn₄O₁₈.H₂O, or any combination thereof.

14. The electrochemical cell of claim 9, wherein the layered material comprises manganese oxide having a predominant crystal structure of α-MnO₂, β-MnO₂, γ-MnO₂, δ-MnO₂, layered, or any combination thereof.

15. The electrochemical cell of claim 13, wherein the layered material comprises Mn₅O₈ that comprises a power having a mean particle diameter of about 50 μm or less.

16. The electrochemical cell of any one of claims 1-15, wherein the cathode further comprises a carbon powder.

17. The electrochemical cell of claim 16, wherein the cathode further comprises about 15 wt % or less of the carbon powder by weight of the cathode.

18. The electrochemical cell of either of claim 16 or 17, wherein the carbon powder comprises acetylene black, furnace black, channel black, graphite, activated carbon, graphene, or any combination thereof.

19. The electrochemical cell of any one of claims 9-18, wherein the cathode further comprises an additive that stabilizes the crystal lattice structure of manganese oxide.

20. The electrochemical cell of claim 19, wherein the additive comprises TiS₂, TiB₂, Bi₂O₃, or any combination thereof.

21. The electrochemical cell of either of claim 19 or 20, wherein the additive is present at a concentration of about 20 wt % or less by weight of the cathode.

22. The electrochemical cell of any one of claims 1-21, wherein the cathode is doped with Al, B, or any combination thereof.

23. The electrochemical cell of any one of claims 1-22, wherein the anode comprises a metal, and a portion of the metal transforms into a divalent cation when the cell is discharged.

24. The electrochemical cell of claim 23, wherein the metal comprises zinc, magnesium, or a combination thereof.

25. The electrochemical cell of any one of claims 1-24, wherein the cathode, the anode, or both further comprises a binder.

26. The electrochemical cell of claim 25, wherein the binder comprises polyacrylonitrile, polyvinyl alcohol, polyvinyl chloride, polyethylene oxide, polytetrafluoroethylene, polyvinylidene difluoride, polymethylmethacrylate, or any combination thereof.

27. The electrochemical cell of either of claim 25 or 26, wherein the binder is present at a concentration of from about 3 wt % to about 15 wt % by weight of the cathode or anode.

28. The electrochemical cell of any one of claims 1-27, wherein the anode, the cathode, or both further comprises a current collector.

29. The electrochemical cell of claim 28, wherein the current collector comprises one or more electrically conductive metals or an electrically conductive polymer material.

30. The electrochemical cell of either of claim 28 or 29, wherein the current collector comprises a woven material, a non-woven material, or a combination thereof.

31. The electrochemical cell of claim 30, wherein the current collector comprises a sheet of non-woven material that optionally comprises one or more perforations.

32. An electrochemical cell comprising:
an aqueous electrolyte comprising a divalent cation that comprises Zn²⁺, Mg²⁺, or a combination thereof;
a cathode comprising a metal oxide; and
an anode comprising zinc metal, magnesium metal, or a combination thereof,
wherein the aqueous electrolyte has a nearly neutral pH, the divalent cation intercalates into the cathode when the cell discharges; and the divalent cation deposits onto the anode as a neutral metal when the cell charges.

33. The electrochemical cell of claim 32, wherein the divalent cation is Zn²⁺.

34. The electrochemical cell of claim 33, wherein the aqueous electrolyte further comprises SO₄²⁻, CHO⁻, NO₃⁻, CO₂CH₃⁻, Cl⁻, Br⁻, ClO₄⁻, or any combination thereof.

35. The electrochemical cell of claim 34, wherein the cathode comprises manganese oxide, and the manganese oxide is not substantially soluble in the aqueous electrolyte.

36. The electrochemical cell of claim 35, wherein the manganese oxide has a chemical formula of MnₓO_{y} where x is greater than or equal to 1, and y is greater than or equal to 2.

37. The electrochemical cell of claim 34, wherein the cathode material comprises manganese vanadium oxide having a chemical formula of MnₓV_{z}O_{y}, where x is greater than or equal to 1, y is greater than or equal to 2, and z is greater than or equal to 1.

38. The electrochemical cell of claim 34, wherein the cathode material comprises manganese oxide having a chemical formula of MnO₂, Mn₅O₈, Mn₃O₇.3H₂O, Mn₇O₁₄.3H₂O, Mn₄O₉.3H₂O, Mn₂O₄, Mn₄O₁₈.H₂O, or any combination thereof.

39. The electrochemical cell of claim 34, wherein the layered material comprises manganese oxide having a predominant crystal structure of α-MnO₂, β-MnO₂, γ-MnO₂, δ-MnO₂, layered, or any combination thereof.

40. The electrochemical cell of claim 38, wherein the manganese oxide has a chemical formula of Mn₅O₈, and the manganese oxide comprises a power having a mean particle diameter of about 50 μm or less.

41. The electrochemical cell of any one of claims 32-40, wherein the cathode further comprises a carbon powder.

42. The electrochemical cell of claim 41, wherein the cathode further comprises about 15 wt % or less of the carbon powder by weight of the cathode.

43. The electrochemical cell of claim 42, wherein the carbon powder comprises acetylene black, furnace black, channel black, graphite, activated carbon, graphene, or any combination thereof.

44. The electrochemical cell of any one of claims 35-43, wherein the cathode further comprises an additive that stabilizes the crystal lattice structure of manganese oxide.

45. The electrochemical cell of claim 44, wherein the additive comprises TiS₂, TiB₂, Bi₂O₃, or any combination thereof.

46. The electrochemical cell of claim 45, wherein the additive is present at a concentration of about 20 wt % or less by weight of the cathode.

47. The electrochemical cell of any one of claims 32-46, wherein the anode comprises zinc metal.

48. The electrochemical cell of any one of claims 32-47, wherein the anode comprises zinc metal and the divalent cation is Zn²⁺.

49. The electrochemical cell of any one of claims 32-48, wherein the anode material, the cathode material, or both further comprises a binder.

50. The electrochemical cell of claim 49, wherein the binder comprises polyacrylonitrile, polyvinyl alcohol, polyvinyl chloride, polyethylene oxide, polytetrafluoroethylene, polyvinylidene difluoride, polymethylmethacrylate, or any combination thereof.

51. The electrochemical cell of either of claim 49 or 50, wherein the binder is present at a concentration of from about 3 wt % to about 15 wt % by weight of the cathode or anode.

52. The electrochemical cell of any one of claims 32-51, wherein the anode, the cathode, or both further comprises a current collector.

53. The electrochemical cell of claim 52, wherein the current collector comprises one or more electrically conductive metals or an electrically conductive polymer material.

54. The electrochemical cell of either of claim 52 or 53, wherein the current collector comprises a woven material, a non-woven material, or a combination thereof.

55. The electrochemical cell of claim 54, wherein the current collector comprises a sheet of non-woven material that optionally comprises perforations.

56. The electrochemical cell of any one of claims 32-55, wherein the cathode is doped with Al, B, or any combination thereof.

57. A method of manufacturing an electrochemical cell comprising:
providing a cathode comprising a layered material;
providing an anode comprising a metal; and
providing an aqueous electrolyte comprising a divalent cation,
wherein the divalent cation intercalates into the layered material when the cell discharges; and the divalent cation de-intercalates from the cathode material and deposits onto the anode material as a neutral metal when the cell charges.

58. The method of claim 57, wherein the divalent cation is selected from Zn²⁺, Ca²⁺, Mg²⁺, Fe²⁺, or any combination thereof.

59. The method of claim 58, wherein the divalent cation is Zn²⁺.

60. The method of claim 59, further comprising dissolving ZnSO₄, Zn(CHO₂)₂, Zn(NO₃)₂, Zn(CO₂CH₃)₂, ZnCl₂, ZnBr₂, Zn(ClO₄)₂, or any combination thereof in water to generate the Zn²⁺ divalent cation.

61. The method of any one of claims 57-60, wherein the cathode comprises a layered material comprising a metal oxide, a mixed metal oxide, a metal sulfide, a zinc metal phosphate, a zinc metal oxide, or any combination thereof.

62. The method of claim 61, wherein the cathode comprises manganese oxide, vanadium oxide, manganese vanadium oxide, TiS₂, WO₂Cl₂, or any combination thereof.

63. The method of either of claim 61 or 62, wherein the cathode comprises a metal oxide that undergoes a reduction in its oxidation state of 1 or more during the discharge of the electrochemical cell.

64. The method of claim 63, wherein the cathode comprises manganese oxide having a chemical formula of MnₓO_{y} and x is greater than or equal to 1, and y is greater than or equal to 2.

65. The method of claim 64, wherein the cathode comprises manganese oxide having a chemical formula of MnO₂, Mn₅O₈, Mn₃O₇.3H₂O, Mn₇O₁₄.3H₂O, Mn₄O₉.3H₂O, Mn₂O₄, Mn₄O₁₈.H₂O, or any combination thereof.

66. The method of claim 64, wherein the cathode comprises manganese oxide having a predominant crystal structure of α-MnO₂, β-MnO₂, γ-MnO₂, δ-MnO₂, layered, or any combination thereof.

67. The method of claim 65, wherein the cathode comprises Mn₅O₈, and the Mn₅O₈ comprises a powder having a mean particle diameter of about 50 μm or less.

68. The method of any one of claims 57-67, wherein the cathode further comprises carbon powder.

69. The method of claim 68, wherein the cathode further comprises about 15 wt % or less of the carbon powder by weight of the cathode.

70. The method of claim 69, wherein the carbon powder comprises acetylene black, furnace black, channel black, graphite, activated carbon, graphene, or any combination thereof.

71. The method of any one of claims 62-70, wherein the cathode further comprises an additive that stabilizes the crystal lattice structure of manganese oxide.

72. The method of claim 71, wherein the additive comprises TiS₂, TiB₂, Bi₂O₃, or any combination thereof.

73. The method of claim 72, wherein the additive is present at a concentration of about 20 wt % or less by weight of the cathode.

74. The method of any one of claims 57-73, wherein the cathode is doped with Al, B, or any combination thereof.

75. The method of any one of claims 57-74, wherein the anode material comprises a metal that undergoes an increase in its oxidation state of 1 or more during the discharge of the electrochemical cell.

76. The method of any one of claims 57-75, wherein the anode comprises zinc metal, magnesium metal, or a combination thereof.

77. The method of any one of claims 57-76, wherein the divalent cation is Zn²⁺, and the anode comprises zinc metal.

78. The method of any one of claims 57-77, wherein the anode material, the cathode material, or both further comprises a binder.

79. The method of claim 78, wherein the binder comprises polyacrylonitrile, polyvinyl alcohol, polyvinyl chloride, polyethylene oxide, polytetrafluoroethylene, polyvinylidene difluoride, polymethylmethacrylate, or any combination thereof.

80. The method of either of claim 78 or 79, wherein the binder is present at a concentration of from about 3 wt % to about 15 wt % by weight of the cathode or anode.

81. The method of any one of claims 57-80, further comprising providing a cathode current collector, an anode current collector, or both.

82. The method of claim 81, wherein the cathode current collector, the anode current collector, or both comprises one or more electrically conductive metals or an electrically conductive polymer material.

83. The method of either of claim 81 or 82, wherein the cathode current collector, the anode current collector, or both comprises a woven material, a non-woven material, or a combination thereof.

84. The method of claim 83, wherein the cathode current collector, the anode current collector, or both comprises a sheet of non-woven material that optionally comprises perforations.
